(19) United States
(12) Patent Application Publication
(10) Pub. No.: US 2012/0006884 A1
(43) Pub. Date: Jan. 12, 2012

(54) CLAD MATERIAL FOR WIRING CONNECTION AND WIRING CONNECTION MEMBER PROCESSED FROM THE CLAD MATERIAL

(75) Inventors: Kazuhiro SHIOMI, Mishima-gun (JP); Masaaki ISHIO, Osaka-shi (JP)

(73) Assignee: NEOMAX MATERIALS CO., LTD., Osaka (JP)

(21) Appl. No.: 13/235,674

(22) Filed: Sep. 19, 2011

Related U.S. Application Data
(63) Continuation of application No. 12/296,735, filed on Oct. 10, 2008.

(30) Foreign Application Priority Data
Apr. 27, 2006 (JP) 2006-123495

(51) Int. Cl. B23K 31/02; B23K 1/20

(52) U.S. Cl. 228/180.5

(57) ABSTRACT

A clad material for a wiring connection has an electroconductive layer formed from either pure Cu or a Cu alloy having higher electroconductivity than pure Al, a surface layer formed from either pure Al or an Al alloy and layered on one surface of the electroconductive layer, and a solder layer formed by hot-dip solder plating on the other surface of the electroconductive layer. The wiring connection member has a first connection end provided with an electroconductive layer soldered to an electrode of a semiconductor element, and a second connection end provided with an electroconductive layer soldered to, for example, an external wiring device. The wiring connection member is processed from the clad material for a wiring connection. This wiring member prevents molten solder from depositing on a pressing and heating portion of a local heating apparatus while also possessing excellent solderability.

### BACKGROUND OF THE INVENTION

1. Field of the Invention

The present invention relates to a clad material for a wiring connection used to electrically connect an electrode of a semiconductor element and an external wiring or the like, and to a clad material for a wiring connection that can be used as a material for the member.

2.Description of the Related Art

To connect the electrodes of a power semiconductor element such as a power diode or IGBT (Insulated Gate Bipolar Transistor) to each other, or to connect an electrode of a semiconductor element and an external wiring, a method is conventionally used in which aluminum wire is connected between the electrodes or between the electrode and external wiring by ultrasonic welding (wire bonding). Such wire bonding, however, has low reliability, limits the allowable current achievable with the aluminum wire, and has other problems.

Therefore, the electrodes of semiconductor elements and external wirings are currently connected using copper-band wiring members instead of using wire bonding based on the use of aluminum wire, as described in Japanese Laid-open Patent Publications 6-268027, 11-163045, and 2002-43508. Such copper-band wiring members are usually connected by soldering. Soldering is sometimes performed by a method in which the ends of a copper-band wiring member are placed via an interposed solder on the electrode of a semiconductor element, which constitutes a component of a semiconductor device (intermediate product), and on an external wiring provided to the substrate of the semiconductor device, and the entire semiconductor device is heated in an inert gas furnace, but generally soldering is performed using a local heating apparatus provided with a pressing and heating portion, such as a soldering iron, to press and heat the ends of the copper-band wiring member used in the soldering process.

As described above, with a copper-band wiring member, an electrode of a semiconductor element or an external wiring is usually soldered by a method in which the upper surface of an end part of the member is heated under pressure. While simple and inexpensive in terms of equipment cost, this method has the following problems. Specifically, pressing and heating a copper-band wiring member by using a local heating apparatus causes the solder disposed between the copper-band wiring member and the electrode or the like to melt, and forces the molten solder to be squeezed out from between the copper-band wiring member and the electrode or the like and to fluidly spread out on the external surface of the copper-band wiring member. As a result, the molten solder often adheres to the pressing and heating portion of the local heating apparatus. Solder dross therefore accumulates on the pressing and heating portion and makes the portion contaminated during repeated soldering. This necessitates removal of the solder dross, and the soldering operation must be suspended during dross removal. As a result, productivity is greatly reduced.

### SUMMARY OF THE INVENTION

In order to overcome the above problems, preferred embodiments of the present invention provide a wiring member that prevents molten solder from adhering on the pressing and heating portion of a local heating apparatus and has excellent solderability, and also provide a material for such a novel wiring member.

The clad material for a wiring connection according to a preferred embodiment of the present invention includes an electroconductive layer formed from a metal having higher electroconductivity than pure Al, and a surface layer formed from pure Al or an Al alloy and layered on one surface of the electroconductive layer. Also, the wiring connection member according to a preferred embodiment of the present invention has a first connection end provided with an electroconductive layer soldered to an electrode of a semiconductor element, and a second connection end provided with an electroconductive layer soldered to an electrode of another semiconductor element or to an external wiring member. The wiring connection member is processed from the clad material for a wiring connection.

In the aforementioned clad material and wiring connection member, a surface layer formed from pure Al or an Al alloy is provided over the electroconductive layer. A dense oxide film is naturally formed on the surface of the surface layer in the atmosphere. Therefore, when solder is placed between an electroconductive layer of a wiring connection member and, for example, an electrode of a semiconductor element, a pressing and heating portion is applied from above to the surface layer of the wiring member to melt the solder, and the electroconductive layer and the electrode or the like are soldered with the molten solder, then the molten solder, even when squeezed out from between the electrode or the like and the wiring connection member, does not fluidly spread out on the surface of the surface layer provided with the dense Al oxide film. Accordingly, the molten solder does not deposit on the pressing and heating portion, it is not necessary to remove solder dross from the pressing and heating portion, and excellent solderability, and hence productivity, is obtained.

A solder layer can also be layered on the other surface of the electroconductive layer in the clad material. The solder layer can be easily formed by plating molten solder onto a bilayer clad material obtained by layering the electroconductive layer and the surface layer. Complicated operations, such as preparing solder and placing the solder in an area to be soldered, must be separately performed to solder a wiring connection material obtained from a bilayer clad material by processing such as cutting or blanking, but the need for such complicated operations is obviated and solderability is further improved by the advance formation of a solder layer.

In the clad material, the electroconductive layer preferably can be formed from pure Cu or a Cu alloy. The surface layer preferably can have a thickness of about 5 to about 30 μm, and the electroconductive layer preferably has a thickness of about 50 to about 250 μm, for example. A plurality of first connection ends and/or a plurality of second connection ends can be provided to the wiring connection member.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is cross-sectional view of the clad material for a wiring connection according to a preferred embodiment of the present invention.

FIG. 2 is a perspective view of the wiring connection member according to a preferred embodiment of the present invention.

FIG. 3 is a partial cross-sectional lateral view of a semiconductor device with a soldered wiring connection member according to a preferred embodiment of the present invention.

FIG. 4 is a perspective view of another wiring connection member.

FIG. 5 is a partial longitudinal sectional view showing an outline of a soldering test.

### DETAILED DESCRIPTION OF THE PREFERRED EMBODIMENTS

The clad material for a wiring connection according to a preferred embodiment of the present invention will now be described with reference to drawings. FIG. 1 shows a cross section of a band-shaped clad material 1 for a wiring connection according to the present preferred embodiment. The material has an electroconductive layer 2 having higher electroconductivity than pure aluminum, a surface layer 3 layered by pressure welding and diffusion bonding on one surface of the electroconductive layer 2, and a solder layer 4 layered on the other surface of the electroconductive layer 2.

A metal having a lower electrical resistance than pure Al, such as pure Cu, pure Ag, or an alloy containing these as a main component, can be used for the electroconductive layer 2. Pure Cu is the most preferred if the materials cost is taken into account. It is possible to use a Cu—Ag alloy, Cu—P alloy, Cu—Sn alloy, Cu—Zn alloy, or other electroconductive alloy whose main component is Cu and in which the content of Cu is 95 mass % or greater. The electroconductive layer 2 preferably has a thickness of at least about 50 μm in order to achieve sufficient electric current capacity. There is no need to increase the thickness beyond 300 μm. The preferred thickness is about 100 μm to about 250 μm, for example.

The surface layer is formed from pure Al or an Al alloy. Any Al alloy can be used because such an alloy naturally forms a dense aluminum oxide film on the surface of the layer in the atmosphere, but a corrosion-resistant Al alloy that is easy to process and has high corrosion resistance is preferred. 1050, 1060, 1085, 1080, 1070, 1N99, 1N90, or the like specified in the JIS can be used as pure Al; and 5052, 3003, 6061, or the like specified in the JIS can be used as the corrosion-resistant aluminum alloy. The thickness of the surface layer is not important as long as a dense aluminum oxide film can be formed on the surface of the layer, and a thickness of about several micrometers is sufficient. A thickness of about 5 to about 30 μm is preferred for the surface layer in terms of the ease of manufacture.

A material having a melting point of about 130 to about 300° C. is preferred for the solder that forms the solder layer 4. Examples of this solder include pure Sn, Sn—Pb alloys, Sn—Ag alloys (0.5 to 5 mass % Ag), Sn—Ag—Cu alloys (0.5 to 5 mass % Ag, 0.3 to 1.0 mass % Cu), Sn—Cu alloys (0.3 to 1.0 mass % Cu), Sn—Ag—In alloys (1.0 to 5.0 mass % Ag, 5 to 8 mass % In), Sn—Ag—Bi alloys (1.0 to 5.0 mass % Ag, 40 to 50 mass % Bi), Sn—Bi alloys (40 to 50 mass % Bi), and Sn—Ag—Bi—In alloys (1.0 to 5.0 mass % Ag, 40 to 50 mass % Bi, 5 to 8 mass % In). Since Pb is biologically harmful and has the potential to pollute the natural environment, it is preferable to use Sn—Ag alloys, Sn—Ag—Cu alloys, Sn—Cu alloys, Sn—Ag—In alloys, Sn—Ag—Bi alloys, and other Pb-free materials from the standpoint of pollution prevention. It is usually sufficient for the thickness of the solder layer to be about 50 μm to about 200 μm, for example.

The clad material is manufactured in the following manner. An electroconductive layer sheet and a surface layer sheet as starting materials for the electroconductive layer 2 and surface layer 3 are prepared, and these sheets are superposed on each other and subjected to cold pressure bonding using rollers at a draft of about 60% to about 80%. The resulting pressure-bonded material is kept for about 1 to about 3 minutes at a temperature of about 300° C. to about 500° C., and the electroconductive layer and surface layer of the pressure-bonded material are bonded to each other by diffusion. The bilayer clad material thus obtained is slit to an appropriate width (usually about 2 mm to about 4 mm, for example), the resulting band plate is passed through a molten solder bath, and the front surface of the electroconductive layer is plated with the molten solder to form a solder layer. A clad material having a three-layer structure provided with a solder layer is thus obtained. Although this is not shown in FIG. 1, hot-dip solder plating also causes the solder to deposit on the side surfaces of the electroconductive layer.

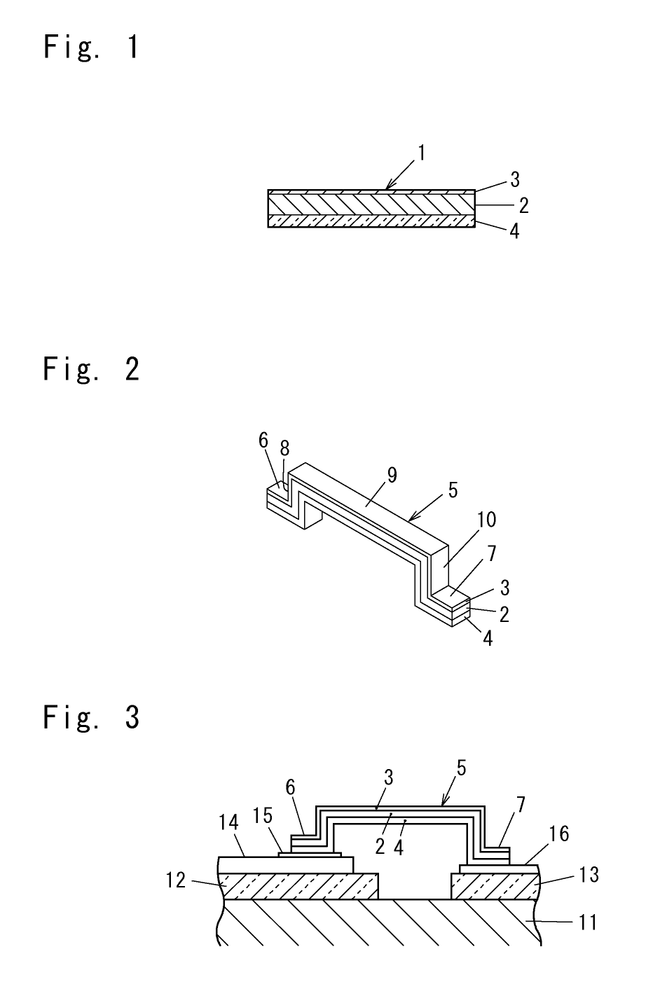

The band-shaped clad material thus manufactured is cut to an appropriate length, bent as shown in FIG. 2, and made into a wiring connection member 5. Since the wiring connection member 5 is cut and bent from the clad material, the member has the same structure in cross section, and the same constituent elements as those of the clad material are designated with the same symbols in FIG. 2. In the wiring connection member 5, a flat first connection end 6 and a flat second connection end 7 are formed at both lateral ends, and the second connection end 7 is coupled with the first connection end 6 via a first leg 8, a link 9, and a second leg 10, in order from the first connection end.

An example of soldering the wiring connection member 5 in a semiconductor device is briefly described below with reference to FIG. 3.

Insulating layers 12, 13 are provided on a substrate 11 such as a copper plate, and a power semiconductor element 14 and external wiring 16 composed of a copper band are provided on top thereof. An electrode 15 composed of a metallized layer is provided to the power semiconductor element 14, and the electrode 15 and the electroconductive layer 2 of the first connection end 6 of the wiring connection member 5, as well as the external wiring 16 and the electroconductive layer 2 of the second connection end 7 of the wiring connection member, are soldered together by the melting and solidification of the solder layer 4 to electrically connect the two components to each other. The soldering is accomplished by applying heat while bringing the pressing and heating portion of a local heating apparatus into contact with the surface layer 3 of the first and second connection ends 6, 7 from above and applying pressure to the layer. In the process, excess molten solder is squeezed out from between the electrode 15 and the electroconductive layer 2 of the first connection end 6, and/or between the external wiring 16 and the electroconductive layer 2 of the second connection end 7, but the solder is prevented from fluidly spreading toward the front surface of the surface layer 3. This is because an aluminum oxide film that is poorly wettable by molten solder is formed on the front surface. The molten solder is therefore prevented from depositing on the pressing and heating portion, and there is no danger of solder dross accumulating.

In the above-described preferred embodiment, hot-dip solder plating is performed and a solder layer is formed after a bilayer clad material has been slit, but it is also possible to slit the bilayer clad material to an appropriate width as needed after the material has been plated by hot-dip solder plating. A strip that serves as a material for the wiring connection member may also be manufactured by producing a flat-plate clad material for a wiring connection and blanking out the strip from the clad material. Furthermore, the solder layer can be layered by another method such as cladding or printing without performing hot-dip solder plating when forming the solder layer.

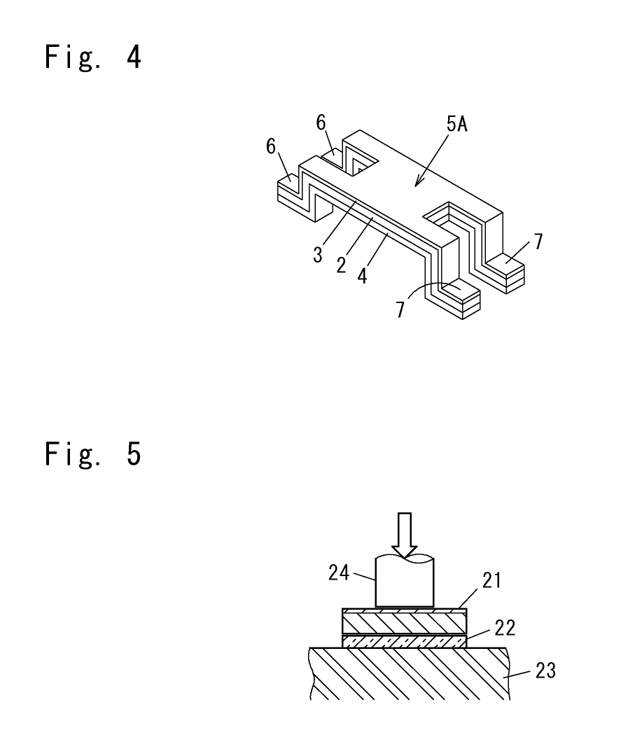

The wiring connection member may have a variety of forms, such as having the first leg 8, the link 9, and the second leg 10 formed integrally in an arch shape. It is further possible to provide a plurality (two in the examples shown) of connection ends 6, 7 in a comb-shaped manner on both sides of a wiring connection member 5A, as shown in FIG. 4. As shown in the example depicted in FIG. 4, a plurality of connection ends are provided on either side of the wiring connection member 5A. However, it is also possible to provide a plurality of connection ends may on only one side. Providing a plurality of connection ends in such a manner yields a connection that has a multipoint structure and results in a more uniform electric current distribution.

A three-layer clad material for a wiring connection is described in the above preferred embodiment, but the clad material for a wiring connection according to the present invention does not necessarily need to be provided with the solder layer 4 and may have a bilayer structure made of the electroconductive layer 2 and surface layer 3. In cases in which a wiring connection member processed from this clad material is soldered to, for example, an electrode of a semiconductor element, solder is placed between the electroconductive layer of the wiring connection member and the electrode of the semiconductor element, and is fused to solder the two components together.

Examples of the clad material for a wiring connection according to preferred embodiments of the present invention are described in detail below, but the present invention should not be construed as being limited by these examples.

### Examples

A pure Cu sheet having a thickness of 0.95 mm, and a pure Al sheet having a thickness of 0.05 mm were superposed on each other and subjected to pressure bonding using rollers at a draft of 70%. The pressure-bonded material was kept at 400° C. for 2 minutes, yielding a bilayer clad material in which a Cu layer (electroconductive layer) and an Al layer (surface layer) were diffusion-bonded to each other. Additionally, the clad material was cold-rolled to produce a bilayer clad material (Cu layer: 190 μm, Al layer: 10 μm) for a wiring connection having a plate thickness of 200 μm, and was punched out by use of a blanking press to obtain a soldering specimen having a diameter of 6 mm. For comparison purposes, a Cu plate having a thickness of 200 μm was punched out to obtain a soldering specimen having a diameter of 6 mm.

Each of the soldering specimens 21 was subsequently superposed on a round solder sheet 22 having a thickness of 100 μm, a diameter of 6 mm, and the composition shown in Table 1, and the soldering specimen and round solder sheet were placed on top of a ceramic plate 23, as shown in FIG. 5. In the clad material specimens, the Cu layer was disposed facing the solder sheet.

The specimens 21 were concentrically pressed with the pressing and heating portion (diameter of distal end portion: 3 mm) 24 of a soldering iron (output: 100 W) to melt the solder sheet 22, and the molten solder was then cooled and solidified. The surface area of the region in which the molten solder had fluidly spread out on the top surface of each of the specimens 21 was measured, and the solder wet surface ratio R was calculated using the formula shown below. The measurement and calculation results are both shown in Table 1.

R=(Surface area wetted with solder/Surface area of specimen)×100%

It can be seen from Table 1 that, whereas molten solder fluidly spreads out on the surface of the Al layer only minimally in specimens designated as sample Nos. 3 and 4 (examples of preferred embodiments of the present invention), the molten solder fluidly spreads out by about 20% in a specimen composed of a Cu plate. It was also learned that, in sample Nos. 1 and 2, the molten solder spread toward the center from the external peripheral edges of the samples to a maximum position of about 2 mm from the center of the samples along the radius.

TABLE 1

| | | | Solder wet | |
|---|---|---|---|---|
| Sample | Specimen | Solder | surface ratio | |
| No. | structure | composition | (%) | Notes |
| 1 | Cu plate | Sn-3.5% Ag | 17% | Comparative |
| | | | | example |
| 2 | Cu plate | 60% Sn—Pb | 21% | Comparative |
| | | | | example |
| 3 | Al/Cu clad | Sn-3.5% Ag | 3% | Example |
| | material | | | |
| 4 | Al/Cu clad | 60% Sn—Pb | 3% | Example |
| | material | | | |

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A soldering method for a wiring connection member including a first connection end soldered to an electrode of a semiconductor element and a second connection end soldered to an electrode of another semiconductor element or to an external wiring, the soldering method comprising the steps of:
forming the wiring connection member made from a clad material including an electroconductive layer made of pure Cu or a Cu alloy and a surface layer made of pure Al or an Al alloy layered on one surface of the electroconductive layer, each of the first and second connection ends including an electroconductive layer portion and a surface layer portion of the clad material;
disposing a solder between the electroconductive layer portion of the first connection end and the electrode of the semiconductor element ,and a solder between the electroconductive layer portion of the second connection end and the electrode of the other semiconductor element or the external wiring; and
soldering the electroconductive layer portion of the first connection end with the electrode of the semiconductor element, and the electroconductive layer portion of the second connection end with the electrode of the other semiconductor element or the external wiring by heating the solders with a pressing and heating portion of a heating apparatus by placing the pressing and heating portion on the surface layer portions of the first and second connection ends to melt the solders via the electroconductive layer portions of the first and second connection ends.

2. A soldering method for a wiring connection member including a first connection end soldered to an electrode of a semiconductor element and a second connection end soldered to an electrode of another semiconductor element or to an external wiring, the soldering method comprising the steps of:
forming the wiring connection member made from a clad material including an electroconductive layer made of pure Cu or a Cu alloy, a surface layer made of pure Al or an Al alloy layered on one surface of the electroconductive layer, and a solder layer layered on another surface of the electroconductive layer, each of the first and second connection ends including an electroconductive layer portion, a surface layer portion, and a solder layer portion of the clad material;
disposing the solder layer portion of the first connection end on the electrode of the semiconductor element and the solder layer portion of the second connection end on the electrode of the other semiconductor element or the external wiring; and
soldering the electroconductive layer portion of the first connection end with the electrode of the semiconductor element, and the electroconductive layer portion of the second connection end with the electrode of the other semiconductor element or the external wiring by heating the solder layer portions with a pressing and heating portion of a heating apparatus by placing the pressing and heating portion on the surface layer portions of the first and second connection ends to melt the solder layer portions via the electroconductive layer portions of the first and second connection ends.

3. The soldering method according to claim 1, wherein the solders are made of a solder having a melting point of about 130° C. to about 300° C.

4. The soldering method according to claim 2, wherein the solder layer is made of a solder having a melting point of about 130° C. to about 300° C.

5. The soldering method according to claim 2, wherein the solder layer is formed by hot-dip solder plating.

6. The soldering method according to claim 1, wherein:
the electroconductive layer has a thickness of about 50 μm to about 250 μm;
the surface layer has a thickness of about 5 μm to about 30 μm; and
the solders have a thickness of about 50 μm to about 200 μm.

7. The soldering method according to claim 2, wherein:
the electroconductive layer has a thickness of about 50 μm to about 250 μm;
the surface layer has a thickness of about 5 μm to about 30 μm; and
the solder layer has a thickness of about 50 μm to about 200 μm.

8. The soldering method according to claim 3, wherein:
the electroconductive layer has a thickness of about 50 μm to about 250 μm;
the surface layer has a thickness of about 5 μm to about 30 μm; and
the solders have a thickness of about 50 μm to about 200 μm.

9. The soldering method according to claim 4, wherein:
the electroconductive layer has a thickness of about 50 μm to about 250 μm;
the surface layer has a thickness of about 5 μm to about 30 μm; and
the solder layer has a thickness of about 50 μm to about 200 μm.

10. The soldering method according to claim 1, wherein the wiring connection member includes at least one of a plurality of first connection ends and a plurality of second connection ends.

11. The soldering method according to claim 2, wherein the wiring connection member includes at least one of a plurality of first connection ends and a plurality of second connection ends.

12. The soldering method according to claim 3, wherein the wiring connection member includes at least one of a plurality of first connection ends and a plurality of second connection ends.

13. The soldering method according to claim 4, wherein the wiring connection member includes at least one of a plurality of first connection ends and a plurality of second connection ends.
